(19) United States
(12) Patent Application Publication
(10) Pub. No.: US 2020/0238414 A1
(43) Pub. Date: Jul. 30, 2020

(54) Multifunctional Integrated Manufacturing System Based On Electrical Arc And Discharge Machining

(71) Applicant: Shanghai Jiao Tong University, Shanghai (CN)

(72) Inventors: Lin Gu, Shanghai (CN); Guojian He, Shanghai (CN)

(73) Assignee: Shanghai Jiao Tong University, Shanghai (CN)

(21) Appl. No.: 16/749,120

(22) Filed: Jan. 22, 2020

(30) Foreign Application Priority Data
Jan. 30, 2019 (CN) 201910089063.1

(51) Int. Cl. B23H 7/30; B23H 7/10; B23H 7/14

(52) U.S. Cl. CPC B23H 7/30; B33Y 30/00; B23H 7/14; B23H 7/10

(57) ABSTRACT

The present invention discloses a multifunction integrated manufacturing system based on electrical machining, including a robot, a motion control unit, a multifunction composite electrical power supply, a working medium supply and recycle unit, a wire feeding device, a tool holder quick-change clamping unit, an electrical machining tool holder, a welding tool holder, a detection tool holder, and a workbench. By using the robot as an actuator, the system can implement discharge additive manufacturing including arc additive forming and micro electrical discharge deposition forming, discharge subtractive machining including efficient arc machining and precise electrical discharge machining, part joining based on arc surfacing, and online detection based on optical scanning and ultrasonic flaw detection. The present invention has a high integration level, covers machining and manufacturing of difficult-to-machine materials and micro parts, and can implement efficient and precise machining. The present invention can be implemented in a variety of media without environmental restrictions thus having a broad application range and having a strong application prospect in extreme environments such as space and deep sea.

### TECHNICAL FIELD

The present invention belongs to the machining and manufacturing field, and in particular, to a multifunction integrated manufacturing system based on electrical machining.

### BACKGROUND

Modern manufacturing technologies can be classified into additive manufacturing (such as 3D printing), subtractive manufacturing (such as cutting and special machining), and equivalent manufacturing (plastic forming). The former two are the most important methods for preparing parts. Additive manufacturing can be used to melt and deposit metal powders or metal wires. Because raw materials have simple shapes and are easy to store and transport, desired shapes can be printed as required. Subtractive manufacturing is the most commonly used machining method at present. Cutting is to remove blank allowance through turning, milling, shaving, grinding and other methods to obtain high-precision parts. Special machining is to remove materials through electrical, thermal, chemical and other means. The development of a multifunction integrated manufacturing system with additive and subtractive manufacturing capabilities is of great significance for improving a level of manufacturing equipment.

Japan's Yamazaki Mazak Corporation has developed machining equipment (“INTERREX i AM” series) that combines lamination modeling of a metal three-dimensional (3D) printer and cutting of a machining center. This equipment uses laser sintering of metal powder to perform 3D printing for near-net forming, and then perform cutting to obtain desired workpieces. Due to low laser absorption of an aluminum alloy, this method is not suitable for printing of an aluminum alloy workpiece. In addition, this equipment adopts a traditional machine tool architecture, and therefore cannot implement machining by using a robot. A size of a machinable part is small and efficiency is very low. In addition, because a service life of a laser head is limited and photoelectric conversion efficiency of the laser is low (a high power <10% and a low power <30%), manufacturing costs, machining costs, and maintenance costs of the entire system are high.

A robot arc additive and subtractive forming device and method are disclosed in the patent CN108145332A by Wang Kehong, et al. In this method, a corresponding three-dimensional model is established for a to-be-machined product by using a computer aided design (CAD) technology, a machining control information code is obtained, and then the robot arc additive machining method and the laser cutting subtractive machining method are sequentially used to machine the product according to a specified path to obtain desired parts. Subtractive machining used in this method is laser cutting, which can only achieve simple contour machining, but other machining equipment is required for workpieces with complex shapes. In addition, sizes and thicknesses of the workpieces are greatly limited in laser machining. Arc additive machining is suitable for workpieces with ordinary macro sizes, but cannot be used to machine micro parts. In addition, high costs, a large size, and low photothermal conversion efficiency of a laser generator also restrict application of this technology in extreme working environments such as navigation and aerospace.

A composite additive and subtractive manufacturing system and method are proposed in the patent CN105574254A by Xiao Wenlei, et al. The system includes a robot, a control unit, arc additive equipment, and subtractive equipment. In the subtractive manufacturing method, mechanical milling is used to remove workpiece materials to implement high-precision machining of workpieces. However, machinable workpiece materials are limited. For difficult-to-cut materials such as high-temperature alloys, titanium alloys, and composite materials widely used in special environments such as aerospace, there are problems of high manufacturing costs and low efficiency. In addition, the cutting force in a milling process causes defects such as machining deformation during machining of thin-walled parts and severe tool abrasion, and a large number of different tools are required to meet the machining requirement. Further, the composite manufacturing system cannot implement additive manufacturing of micro parts due to the technical features of arc additive forming.

In view of the above, the existing integrated additive and subtractive manufacturing system has a low function integration level, and the system's additive manufacturing function cannot implement machining and manufacturing of micro parts. Furthermore, the subtractive manufacturing function has limited machining features or has high machining costs and low machining efficiency and requires many tools for difficult-to-machine materials.

### SUMMARY

To overcome disadvantages mentioned above, the present invention provides a multifunction integrated manufacturing system based on electrical machining.

The present invention is intended to provide a new multifunctional manufacturing system which integrates material addition and subtraction with detection functions. The principle of the present invention is as follows: By using a rotor as a platform and relying on an electrical machining technology, the integrated manufacturing system can implement an additive manufacturing function by using electrical arc or micro electrical discharge deposition, furthermore, electrical arc or discharge subtractive machining undertake the function of material removing, and an online detection function based on optical scanning or ultrasonic detection. Micro electrical discharge deposition can implement additive machining of micro parts. Therefore, both micro parts and macro parts are taken into account in the additive machining in the present invention. In addition, bulk material subtractive machining can be performed by applying electrical arc machining and finishing machining can be fulfilled by electrical discharge machining. In both methods, a high-temperature plasma formed by arc or discharge is used to perform thermal ablation on workpiece surface materials, and machining performance is not influenced by strength and hardness of the workpiece materials. Therefore, a good machining effect can also be achieved for difficult-to-cut materials. Optical scanning can be performed to measure the dimension tolerance precisely, as well as applied to provide guidance for machining parameter and strategy adjustment. Ultrasonic detection can be used to find surface and internal defects of the machined workpiece, thereby ensuring the quality of the machined part.

The objective of the present invention is implemented through the following technical solutions:

A multifunction integrated manufacturing system based on electrical machining is provided, including a robot, a motion control unit, a multifunction composite electrical power supply, a working medium supply and recycle unit, a tool holder quick-change clamping unit, and a workbench. The motion control unit is connected to the robot and controls a machining feed path of the robot, the tool holder quick-change clamping unit is mounted at an end of the robot, a workpiece is fixed to the workbench, a positive electrode and a negative electrode of the multifunction composite electrical power supply are respectively connected to the workbench and the quick-change clamping unit, an outlet end and an inlet end of the working medium supply and recycle unit are respectively connected to the quick-change clamping unit and the workbench, and the working medium supply and recycle unit provides a working medium for the machining process. The system further includes: an electrical machining tool holder used for subtractive electrical machining; a wire feeding device and a welding tool holder used for additive electrical manufacturing; and a detection tool holder used for online detection. The electrical machining tool holder, the welding tool holder, or the detection tool holder can be interchangeably clamped on the quick-change clamping unit as required.

Preferably, a power supply required for electrical machining connects with the electrical machining tool holder and the workpiece to form an arc or discharge circuit, and the subtractive electrical machining function is performed on the workpiece by cooperatively using the robot, motion control unit, the multifunction composite electrical power supply, the working medium supply and recycle unit, the tool holder and quick-change clamping unit, the electrical machining tool holder, and the workbench.

Preferably, the discharge subtractive machining function is implemented by using an efficient arc machining method and an electrical discharge machining method.

Preferably, the wire feeding device delivers an electrode wire to the quick-change clamping unit and finally to the welding tool holder, an electrical power supply required for electrical machining connects with the welding tool holder and the workpiece, and a discharge additive manufacturing function and a part joining function are implemented by cooperatively using the robot, the motion control unit, the wire feeding device, the multifunction composite electrical power supply, the working medium supply and recycle unit, the tool holder quick-change clamping unit, the welding tool holder, and the workbench.

Preferably, the additive manufacturing function is implemented by using arc deposition or micro electrical discharge deposition method, and the part joining function is implemented by using arc welding method.

Preferably, an online detection function on the workpiece is implemented by cooperatively using the robot, the motion control unit, the tool holder quick-change clamping unit, the detection tool holder, and the workbench.

Preferably, the online detection function is to detect a three-dimensional shape and surface quality of a part through optical scanning or implement flaw detection on a machined part by using an ultrasonic method.

Preferably, the multifunction composite electrical power supply is a pulse power supply or a direct current power supply whose discharge current is adjustable within a range of 0.1-1000 A and whose pulse width and pulse interval are adjustable between 0.1 μs and 100 ms, the multifunction composite electrical power supply has a 5-level power parameter output mode, and the 5-level power parameter output mode is separately used for efficient arc machining, precise electrical discharge machining, arc additive forming, arc surfacing, and micro electrical discharge deposition forming.

Preferably, a tail of the tool holder quick-change clamping unit is equipped with a quick connector, and quick clamping and replacement of the electrical machining tool holder, the welding tool holder, or the detection tool holder are implemented through the quick connector.

Preferably, the tool holder quick-change clamping unit has an interface connected to the electrical power supply, the wire feeding device, and the working medium supply and recycle unit, and the electrical machining tool holder or the welding tool holder mounted at an end of the tool holder quick-change clamping unit is provided with loading of the electrical power supply, delivery of an electrode wire, and supply of a working medium through the connection of the interface.

Preferably, a working medium supplied by the working medium supply and recycle unit includes a water-based working fluid, an oil-based working fluid, air, a mist medium, or a welding protective gas, a supply pressure range of the working medium is 0-10 MPa, and a filtering unit is arranged in the working medium supply and recycle unit to filter the working medium in a circulating manner.

Compared with the prior art, beneficial effects of the present invention lie in:

1. The present invention has a high function integration level and strong process adaptability. Relying on the robot's working platform and common interface, the system integrates the additive manufacturing function implemented by using the arc additive forming method and the micro electrical discharge deposition forming method, the subtractive machining function implemented by using the arc machining method and the electrical discharge machining method, the part joining function implemented by using the arc surfacing method, and the online detection function implemented through optical scanning and ultrasonic flaw detection. The present invention not only can implement quick preparation of workpieces through additive manufacturing based on metal wires, but also can be used for rapidly repairing damaged metal parts. Additive manufacturing is integrated with subtractive manufacturing to implement rapid and high-precision preparation of metal components. In addition, quality detection and process optimization of machined workpieces can be implemented through optical and ultrasonic detection modules.

2. The present invention has a broad machining application range, and is particularly applied to machining and manufacturing of difficult-to-machine materials and micro parts. Machining and manufacturing of micro parts are taken into account in the micro electrical discharge deposition forming method in the additive manufacturing function. In the arc machining and electrical discharge machining methods in the subtractive machining function, a high-temperature plasma formed by discharge is used to perform thermal ablation on workpiece surface materials, and machining performance is not affected by strength and hardness of the workpiece materials. Therefore, a good machining effect can also be produced for difficult-to-machine materials. In addition, a variety of arc machining and electrical discharge machining methods including immersion and discharge milling ensure that parts with complex curve surfaces can be produced and manufactured in the system.

3. The present invention can implement efficient and precise machining. Arc machining can be used to rapidly remove workpiece materials, and electrical discharge machining can be used to perform finishing on a small allowance, which are perfectly complementary.

4. The present invention has strong environmental adaptability. The system can be implemented in a variety of working media such as a water-based working fluid, an oil-based working fluid, air, a mist medium, and a welding protective gas without environmental restrictions and has a strong application prospect in extreme working environments such as space and deep sea.

### BRIEF DESCRIPTION OF THE DRAWINGS

FIG. 1 is a schematic structural diagram of a multifunction integrated manufacturing system based on electrical machining according to the present invention;

FIG. 2 is a schematic diagram of an integrated function of a multifunction integrated manufacturing system according to the present invention;

FIG. 3 is a schematic diagram of performing integrated manufacturing on a frame part by using the present invention in Embodiment 1;

FIG. 4 is a schematic diagram of performing discharge additive manufacturing on a blade part by using the present invention in Embodiment 2; and

FIG. 5 is a schematic diagram of performing integrated manufacturing on a micro-electro-mechanical system (MEMS) part by using the present invention in Embodiment 3.

Reference numerals: 1. Robot; 2. Motion control unit; 3. Wire feeding device; 4. Multifunction composite electrical power supply; 5. Working medium supply and recycle unit; 6. Tool holder quick-change clamping unit; 7. Electrical machining tool holder; 8. Welding tool holder; 9. Detection tool holder; 10. Workpiece; 11. Workbench.

### DETAILED DESCRIPTION

The following clearly and completely describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

It should be noted that when a component “fixed to” another component, the component may be directly on the another component or there may be an intermediate component. When a component is “connected” to another component, the component may be directly connected to the another component or there may be an intermediate component. When a component is “arranged on” another component, the component may be directly arranged on the another component or there may be an intermediate component The terms “vertical”, “horizontal”, “left”, and “right” and similar expressions used herein are for illustrative purposes only.

Unless otherwise defined, all technical and scientific terms used herein have the same meaning as those commonly understood by those skilled in the art of the present invention. The terms used herein are merely for the purpose of describing specific embodiments, and is not intended to limit the present invention. The term “and/or” used herein includes any and all combinations of one or more of the associated listed items.

### I. SYSTEM STRUCTURE AND CONNECTION RELATIONSHIP

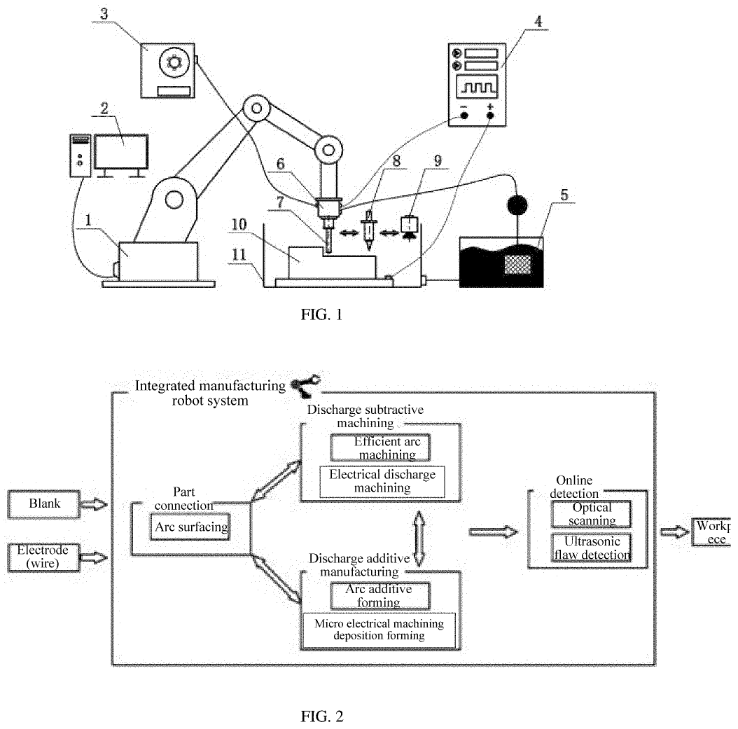

Referring to FIG. 1, a multifunction integrated manufacturing system based on electrical machining in the present invention includes a robot 1, a motion control unit 2, a wire feeding device 3, a multifunction composite electrical power supply 4, a working medium supply and recycle unit 5, a tool holder quick-change clamping unit 6, an electrical machining tool holder 7, a welding tool holder 8, a detection tool holder 9, and a workbench 11.

The motion control unit 2 is connected to the robot 1 and controls a machining feed path of the robot 1, the tool holder quick-change clamping unit 6 is mounted at an end of the robot 1, a workpiece 10 is fixed to the workbench 11, a positive electrode and a negative electrode of the multifunction composite electrical power supply 4 are respectively connected to the workbench 11 and the quick-change clamping unit 6, an outlet end and an inlet end of the working medium supply and recycle unit 5 are respectively connected to the quick-change clamping unit 6 and the workbench 11, and the working medium supply and recycle unit 5 provides a working medium for a machining process.

The electrical machining tool holder 7 is used for discharge subtractive machining. The wire feeding device 3 and the welding tool holder 8 are used for additive electrical manufacturing. The detection tool holder 9 is used for online detection on a part. The electrical machining tool holder 7, the welding tool holder 8, or the detection tool holder 9 can be interchangeably clamped on the quick-change clamping unit 6 as required.

A power supply required for electrical machining connects with the electrical machining tool holder 7 and the workpiece 10 to form an arc or discharge circuit, and the subtractive electrical machining function is performed on the workpiece 10 by cooperatively using the robot 1, the motion control unit 2, the multifunction composite electrical power supply 4, the working medium supply and recycle unit 5, the tool holder quick-change clamping unit 6, the electrical machining tool holder 7, and the workbench 11. The discharge subtractive machining function is implemented by using an efficient arc machining method and an electrical discharge machining method.

The wire feeding device 3 delivers an electrode wire to the quick-change clamping unit 6 and finally to the welding tool holder 8, an electrical power supply required for electrical machining connects with the welding tool holder 8 and the workpiece 10, and a discharge additive manufacturing function and a part joining function are implemented by cooperatively using the robot 1, the motion control unit 2, the wire feeding device 3, the multifunction composite electrical power supply 4, the working medium supply and recycle unit 5, the tool holder quick-change clamping unit 6, the welding tool holder 8, and the workbench 11. The additive manufacturing function is implemented by using arc deposition or micro electrical discharge deposition method, and the part joining function is implemented by using arc welding method.

An online detection function on the workpiece 10 is implemented by cooperatively using the robot 1, the motion control unit 2, the tool holder quick-change clamping unit 6, the detection tool holder 9, and the workbench 11. The online detection function is to detect a three-dimensional shape and surface quality of a part through optical scanning or implement flaw detection on a machined part by using an ultrasonic method.

The multifunction composite electrical power supply 4 is a pulse power supply or a direct current power supply whose discharge current is adjustable within a range of 0.1-1000 A and whose pulse width and pulse interval are adjustable between 0.1 μs and 100 ms, the multifunction composite electrical power supply 4 has a 5-level power parameter output mode, and the 5-level power parameter output mode is separately used for efficient arc machining, precise electrical discharge machining, arc additive forming, arc surfacing, and micro electrical discharge deposition forming.

A tail of the tool holder quick-change clamping unit 6 is equipped with a quick connector, and quick clamping and replacement of the electrical machining tool holder 7, the welding tool holder 8, or the detection tool holder 9 are implemented through the quick connector.

The tool holder quick-change clamping unit 6 has an interface connected to the electrical power supply 4, the wire feeding device 3, and the working medium supply and recycle unit 5, and the electrical machining tool holder 7 or the welding tool holder 8 mounted at an end of the tool holder quick-change clamping unit 6 is provided with loading of the electrical power supply, delivery of an electrode wire, and supply of a working medium through the connection of the interface.

A working medium supplied by the working medium supply and recycle unit 5 includes a water-based working fluid, an oil-based working fluid, air, a mist medium, or a welding protective gas, a supply pressure range of the working medium is 0-10 MPa, and a filtering unit is arranged in the working medium supply and recycle unit 5 to filter the working medium in a circulating manner.

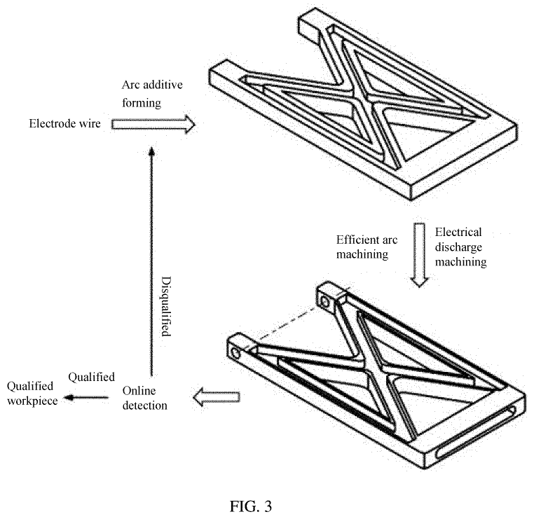

### II. WORKING PRINCIPLE OF THE SYSTEM AND MACHINING PROCESS FOR 5-LEVEL CONVERSION (REFERRING TO FIG. 1 AND FIG. 2)

1. Efficient Arc Machining

(1). The tool holder quick-change clamping unit 6 is mounted at the end of the robot 1, the electrical machining tool holder 7 is clamped on the quick-change clamping unit 6, and the to-be-machined workpiece 10 is fixed to the workbench 11.

(2). The positive electrode and the negative electrode of the multifunction composite electrical power supply 4 are respectively connected to the tool holder quick-change clamping unit 6 and the workbench 11, a power parameter output mode of the electrical power supply 4 is set to a level 1, and then parameters such as a peak current, an open circuit voltage, a pulse width, and a pulse interval are specifically set, to form a discharge circuit required for arc machining between the electrical machining tool holder 7 and the workpiece 10.

(3). The outlet end and the inlet end of the working medium supply and recycle unit 5 are respectively connected to the tool holder quick-change clamping unit 6 and the workbench 11 to provide a working medium such as a water-based working fluid, an oil-based working fluid, a mist medium, or air for arc machining, and appropriate values are set for flow and pressure of the working medium.

(4). The motion control unit 2 is connected to the robot 1 and controls a machining feed path of the electrical machining tool holder 7 according to a machining code input into the motion control unit 2, so that a discharge breakdown is formed between the electrical machining tool holder 7 and the workpiece 10, thereby performing stable arc machining to complete machining of a workpiece with a specific shape.

2. Precise Electrical Discharge Machining

The power parameter output mode of the electrical power supply 4 is set to a level 2, and then parameters such as a peak current, an open circuit voltage, a pulse width, and a pulse interval are specifically set, to form a discharge circuit required for electrical discharge machining between the electrical machining tool holder 7 and the workpiece 10. Other steps are basically the same as those in efficient arc machining.

3. Arc Additive Forming

(1). The tool holder quick-change clamping unit 6 is mounted at the end of the robot 1, and the welding tool holder 8 is clamped on the quick-change clamping unit 6.

(2). The wire feeding device 3 is connected to the tool holder quick-change clamping unit 6 and delivers the electrode wire to the welding tool holder 8 through the quick-change clamping unit 6.

(3). The positive end and the negative electrode of the multifunction composite electrical power supply 4 are respectively connected to the tool holder quick-change clamping unit 6 and the workbench 11, the power parameter output mode of the electrical power supply 4 is set to a level 3, and then discharge parameters are specifically set, to form a discharge circuit required for arc additive forming.

(4). The outlet end and the inlet end of the working medium supply and recycle unit 5 are respectively connected to the tool holder quick-change clamping unit 6 and the workbench 11 to provide a working medium for arc additive forming.

(5). The motion control unit 2 is connected to the robot 1 and controls a feed path of the welding tool holder 8 according to a machining code input to the motion control unit 2, to complete arc additive forming of a workpiece with a specific shape.

4. Part Joining

Part joining based on arc surfacing can be understood as arc additive forming at a position in which parts need to be connected. Therefore, an implementation process of part joining is basically the same as the process of arc addition forming, that is, the power parameter output mode of the electrical power supply 4 is set to a level 4, and the to-be-connected parts are placed on the workbench.

5. Micro Electrical Discharge Deposition

The power parameter output mode of the multifunction composite electrical power supply 4 is set to a level 5, and other steps are similar to those of arc additive forming.

(1). The tool holder quick-change clamping unit 6 is mounted at the end of the robot 1, and the detection tool holder 9 is clamped on the quick-change clamping unit 6.

(2). The multifunction composite electrical power supply 4 is cut off.

(3). The motion control unit 2 is connected to the robot 1, and the robot 1 drives the detection tool holder 9 to perform optical scanning or ultrasonic flaw detection on the workpiece 10 on the workbench 11 according to a code in the motion control unit 2, to complete online detection on quality of the workpiece.

### III. SPECIFIC EMBODIMENTS

### Embodiment 1

As shown in FIG. 3, a three-dimensional size of an outer contour of a frame part is 600 mm×310 mm×40 mm, and a material of the part is a nickel-based superalloy. A process of machining and manufacturing the part by using the present invention is as follows:

(1). The power parameter output mode of the multifunction composite electrical power supply 4 is set to a level 3 (an arc additive forming mode), and the current is set to 100 A, so that the working medium supply and recycle unit 5 provides a welding protective gas and performs arc additive forming to machine a frame part that retains a finishing allowance.

(2). The power parameter output mode of the multifunction composite electrical power supply 4 is set to a level 1 (an efficient arc machining mode), the peak current is set to 500 A, the pulse width is set to 6 ms, the pulse interval is set to 4 ms, and the open circuit voltage is set to 90 V, so that the working medium supply and recycle unit 5 provides a water-based working fluid and performs efficient arc machining to further machine two through holes on side surfaces and a square cavity on the part in step (1).

(3). The power parameter output mode of the multifunction composite electrical power supply 4 is set to a level 2 (a precise electrical discharge machining mode), the peak current is set to 15 A, the pulse width is set to 60 μs, the pulse interval is set to 100 μs, and the open circuit voltage is set to 120 V, so that the working medium supply and recycle unit 5 provides an oil-based working fluid and performs precise electrical discharge machining on a surface of the rough workpiece formed in the first two steps.

(4). On-line detection is performed on a size and quality of the workpiece machined in step (3). If the size does not meet a drawing requirement, the foregoing steps are repeatedly performed as required, and detection is performed again until the requirement is fully met.

### Embodiment 2

As shown in FIG. 4, there is a defect in a blade part, and additive manufacturing is performed by using the integrated manufacturing system in the present invention.

(1). The defective blade workpiece is placed on the workbench 11 and the online detection function of the system in the present invention is used to perform optical scanning on the defect and inversely obtain a shape of the defect according to a three-dimensional model of the original workpiece.

(2). The power parameter output mode of the multifunction composite electrical power supply 4 is set to a level 3 (an arc additive forming mode), and the current is set to 100 A, so that the working medium supply and recycle unit 5 provides a welding protective gas and performs filling and repairing on the defect through arc additive forming according to the defect shape obtained inversely.

(3). Because a surface after arc additive forming is relatively rough, finishing needs to be performed on the surface. The power parameter output mode of the multifunction composite electrical power supply 4 is set to a level 2 (a precise electrical discharge machining mode), the peak current is set to 15 A, the pulse width is set to 60 μs, the pulse interval is set to 100 μs, and the open circuit voltage is set to 120 V, so that the working medium supply and recycle unit 5 provides an oil-based working fluid and performs local precise electrical discharge machining on the defect filled in step (2).

### Embodiment 3

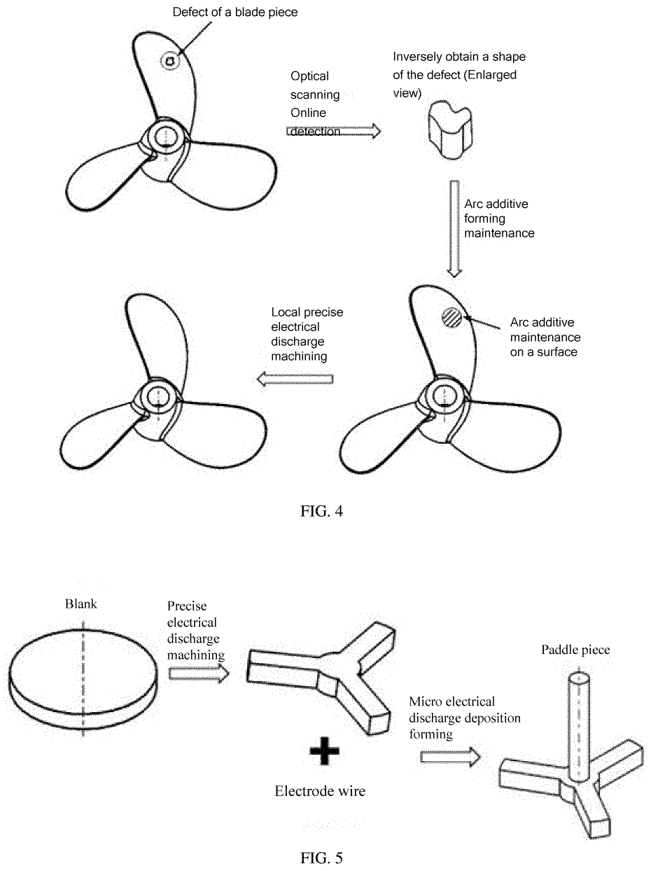

As shown in FIG. 5, a micro-electro-mechanical system (MEMS) paddle part has a paddle shaft diameter of 0.2 mm, a height of 1.2 mm, a blade outer diameter of 1.6 mm, and a thickness of 0.2 mm. A material of the part is stainless steel. A process of machining and manufacturing the part by using the present invention is as follows:

(1). The power parameter output mode of the multifunction composite electrical power supply 4 is set to a level 2 (a precise electrical discharge machining mode), the peak current is set to 5 A, the pulse width is set to 10 μs, the pulse interval is set to 20 μs, and the open circuit voltage is set to 120 V, so that the working medium supply and recycle unit 5 provides an oil-based working fluid and performs precise electrical discharge machining on a disk blank having a diameter of 1.8 mm and a thickness of 0.2 mm to obtain an impeller shown in FIG. 3.

(2). The impeller machined in step (1) is placed on the workbench 11, the power parameter output mode of the multifunction composite electrical power supply 4 is set to a level 5 (a micro electrical discharge deposition forming mode), the peak current is set to 4 A, the pulse width is set to 8 μs, the pulse interval is set to 120 μs, and the open circuit voltage is set to 100 V, so that the working medium supply and recycle unit 5 provides an air medium and performs micro electrical discharge deposition forming at a center of the machined impeller to obtain a paddle shaft and finally form the paddle part.

(3). On-line detection is performed on a size and quality of the workpiece machined in step (2). If the size does not meet a drawing requirement, the foregoing steps are repeatedly performed as required, and detection is performed again until the requirement is fully met.

The foregoing descriptions of specific embodiments of the present invention are presented for purposes of illustration and description. These descriptions are not intended to limit the present invention to the precise forms disclosed, and obviously many modifications and variations are possible in light of the above teaching. The exemplary embodiments are chosen and described in order to explain certain principles of the present invention and its practical application, to enable a person skilled in the art to make and utilize various exemplary embodiments of the present invention, as well as various alternatives and modifications thereof. That is, for a person skilled in the art, a variety of other corresponding modifications and variations can be made according to the above-described technical solutions and concepts, and all the modifications and variations shall fall within the protection scope of the claims of the present invention.

What is claimed is:

1. A multifunction integrated manufacturing system based on electrical machining, comprising a robot (1), a motion control unit (2), a multifunction composite electrical power supply (4), a working medium supply and recycle unit (5), a tool holder quick-change clamping unit (6), and a workbench (11), wherein the motion control unit (2) is connected to the robot (1) and controls a machining feed path of the robot (1), the tool holder quick-change clamping unit (6) is mounted at an end of the robot (1), a workpiece (10) is fixed to the workbench (11), a positive electrode and a negative electrode of the multifunction composite electrical power supply (4) are respectively connected to the workbench (11) and the quick-change clamping unit (6), an outlet end and an inlet end of the working medium supply and recycle unit (5) are respectively connected to the quick-change clamping unit (6) and the workbench (11), and the working medium supply and recycle unit (5) provides a working medium for a machining process; and the system further comprises:
an electrical machining tool holder (7) used for discharge subtractive machining;
a wire feeding device (3) and a welding tool holder (8) used for additive electrical manufacturing; and
a detection tool holder (9) used for online detection, wherein
the electrical machining tool holder (7), the welding tool holder (8), or the detection tool holder (9) can be interchangeably clamped on the quick-change clamping unit (6) as required.

2. The multifunction integrated manufacturing system according to claim 1, wherein a power supply required for electrical machining connects with the electrical machining tool holder (7) and the workpiece (10) to form an arc or discharge circuit, and the subtractive electrical machining function is performed on the workpiece by cooperatively using the robot (1), the motion control unit (2), the multifunction composite electrical power supply (4), the working medium supply and recycle unit (5), the tool holder quick-change clamping unit (6), the electrical machining tool holder (7), and the workbench (11).

3. The multifunction integrated manufacturing system according to claim 2, wherein the discharge subtractive machining function is implemented by using an efficient arc machining method and an electrical discharge machining method.

4. The multifunction integrated manufacturing system according to claim 1, wherein the wire feeding device (3) delivers an electrode wire to the quick-change clamping unit (6) and finally to the welding tool holder (8), a discharge circuit required for electrical discharge machining is formed between the welding tool holder (8) and the workpiece (10), and a discharge additive manufacturing function and a part joining function are implemented by cooperatively using the robot (1), the motion control unit (2), the wire feeding device (3), the multifunction composite electrical power supply (4), the working medium supply and recycle unit (5), the tool holder quick-change clamping unit (6), the welding tool holder (8), and the workbench (11).

5. The multifunction integrated manufacturing system according to claim 4, wherein the additive manufacturing function is implemented by using arc deposition or micro electrical discharge deposition method, and the part joining function is implemented by using arc welding method.

6. The multifunction integrated manufacturing system according to claim 1, wherein an online detection function on the workpiece (10) is implemented by cooperatively using the robot (1), the motion control unit (2), the tool holder quick-change clamping unit (6), the detection tool holder (9), and the workbench (11).

7. The multifunction integrated manufacturing system according to claim 6, wherein the online detection function is to detect a three-dimensional shape and surface quality of a part through optical scanning or implement flaw detection on a machined part by using an ultrasonic method.

8. The multifunction integrated manufacturing system according to claim 1, wherein the multifunction composite electrical power supply (4) is a pulse power supply or a direct current power supply whose discharge current is adjustable within a range of 0.1-1000 A and whose pulse width and pulse interval are adjustable between 0.1 μs and 100 ms, the multifunction composite electrical power supply (4) has a 5-level power parameter output mode, and the 5-level power parameter output mode is separately used for efficient arc machining, precise electrical discharge machining, arc additive forming, arc surfacing, and micro electrical discharge deposition forming.

9. The multifunction integrated manufacturing system according to claim 1, wherein a tail of the tool holder quick-change clamping unit (6) is equipped with a quick connector, and quick clamping and replacement of the electrical machining tool holder (7), the welding tool holder (8), or the detection tool holder (9) are implemented through the quick connector.

10. The multifunction integrated manufacturing system according to claim 1, wherein the tool holder quick-change clamping unit (6) has an interface connected to the electrical power supply (4), the wire feeding device (3), and the working medium supply and recycle unit (5), and the electrical machining tool holder (7) or the welding tool holder (8) mounted at an end of the tool holder quick-change clamping unit (6) is provided with loading of the electrical power supply, delivery of an electrode wire, and supply of a working medium through the connection of the interface.

11. The multifunction integrated manufacturing system according to claim 1, wherein a working medium supplied by the working medium supply and recycle unit (5) comprises a water-based working fluid, an oil-based working fluid, air, a mist medium, or a welding protective gas, a supply pressure range of the working medium is 0-10 MPa, and a filtering unit is arranged in the working medium supply and recycle unit (5) to filter the working medium in a circulating manner.
